(19) United States
(12) Patent Application Publication
(10) Pub. No.: US 2024/0301104 A1
(43) Pub. Date: Sep. 12, 2024

(54) USE OF A SWELLING AGENT IN MULTI-STAGE POLYOLEFIN PRODUCTION

(71) Applicant: BOREALIS AG, Vienna (AT)

(72) Inventors: Matthias HOFF, Linz (AT); Joana Elvira KETTNER, Linz (AT); Vasileios KANELLOPOULOS, Linz (AT); Victor SUMERIN, Porvoo (FI); Jani AHO, Porvoo (FI); Apostolos KRALLIS, Porvoo (FI); Kalle KALLIO, Porvoo (FI); Irfan SAEED, Porvoo (FI); Erno ELOVAINIO, Porvoo (FI)

(21) Appl. No.: 18/572,402

(22) PCT Filed: Jun. 23, 2022
(86) PCT No.: PCT/EP2022/067173

§ 371 Date: Dec. 20, 2023

(30) Foreign Application Priority Data
Jun. 24, 2021 (EP) 21181472.8

(51) Int. Cl. C08F 210/16; C08L 23/08

(52) U.S. Cl. CPC C08F 210/16; C08L 23/0815; C08L 2205/025; C08L 2308/00

(57) ABSTRACT

The disclosure relates to a process for polymerising olefins in multi stage polymerisation process configuration, comprising a) polymerising in a first polymerisation step first olefin monomer, optionally in the presence of at least one other alpha olefin monomer, in the presence of a polymerisation catalyst so as to form a first polymer component (A), and b) polymerising in a second polymerisation step in gas phase second olefin monomer, optionally in the presence of at least one other alpha olefin comonomer, in the presence of the first polymer component (A) of step a) and an induced swelling agent, so as to for a second polymer component (B), wherein the first polymer component (A) and the second polymer component (B) are produced at production rates meeting a predetermined target weight ratio of the second polymer component (B) to the first polymer component (A), the process comprising the steps of: i) determining a first weight ratio of the second polymer component (B) to the first polymer component (A) in the second polymerisation step, and ii) increasing the concentration of the induced swelling agent in the second polymerisation step if the determined first weight ratio is less than the predetermined target weight ratio, or iii) decreasing the concentration of the induced swelling agent in the second polymerisation step if the determined first weight ratio is greater than the predetermined target weight ratio, or iv) maintaining the concentration of the induced swelling agent in the second polymerisation step if the determined first weight ratio equals the predetermined target weight ratio. The disclosure further relates to use of an induced swelling agent in a gas phase polymerisation step for improving gas phase production split in a multi-stage olefin polymerisation process.

### FIELD OF THE DISCLOSURE

The present disclosure relates to polymerisation of olefins and more particularly to a multi-stage polyolefin productions process. The present disclosure further concerns the use of an induced swelling agent in a gas phase polymerisation step for improving gas-phase reactor production split in multi-stage olefin polymerisation process.

### BACKGROUND OF THE DISCLOSURE

Multi-stage polyolefin production processes (e.g. Borstar PE, PP and Spheripol PP) consist of multi-stage reactor configuration to give the multi-modal capability for achieving easy to process resins with desired mechanical properties. In such processes, a combination of slurry loop reactors in series followed by a gas phase reactor is employed to produce a full range of polyolefins.

A key feature weof the aforementioned materials produced in multi-stage olefin polymerisation processes is to achieve a desired production split in order to meet the requirements of the product portfolio without sacrificing the production throughput. In general, the product portfolio can be largely widened/enhanced if the GPR production split could be increased for a given production throughput.

Among other process parameters and operating procedures, the GPR production split largely depends on the catalyst kinetic profiles. For instance, a catalytic system that exhibits a fast decay activity (i.e., high initial activity in the loop reactors and decaying activity in the gas phase reactor) introduces a number of challenges towards achieving the desired production split. Moreover, even in a slowly decay activity catalyst (i.e., relatively flat catalyst activity profile), means, or methods to increase the GPR production split in multi-stage reactor configurations are also desired.

In the recent years, a number of challenges have been observed in achieving a target loop/GPR split when single-site catalysts are employed. The decrease of catalyst activity in the gas phase fluidized bed reactor combined with the relatively low particle growth rates resulted in difficulties to achieve the desire split, so that to produce the targeted product fleet.

### BRIEF DESCRIPTION OF THE DISCLOSURE

An object of the present disclosure is to provide a process for polymerising olefins in multi stage polymerisation process configuration so as to overcome the above problems.

The object of the disclosure is achieved by a process and use, which are characterized by what is stated in the independent claims. The preferred embodiments of the disclosure are disclosed in the dependent claims.

The disclosure is based on the idea of adjusting of the concentration of an induced swelling agent in a second polymerisation step to a desirable level that allows control of the production rates and meeting a predetermined target weight ratio of the second polymer to the first polymer. This increases the catalyst productivity in the second polymerisation step, further improves the production split in the second polymerisation step and broadens the product window of a multi-stage polymerisation processes that operate for long overall residence time.

### DETAILED DESCRIPTION OF THE DISCLOSURE

The disclosure relates to a process for polymerising olefins in multi stage polymerisation process configuration, comprising,
a) polymerising in a first polymerisation step first olefin monomer, optionally in the presence of at least one other alpha olefin monomer, in the presence of a polymerisation catalyst so as to form a first polymer component (A) and
b) polymerising in a second polymerisation step in gas phase second olefin monomer, optionally in the presence of at least one other alpha olefin comonomer, in the presence of the first polymer component (A) of step a) and an induced swelling agent, so as to form a second polymer component (B), wherein the first polymer component (A) and the second polymer component (B) are produced at production rates meeting a predetermined target weight ratio of the second polymer component (B) to the first polymer component (A), the process comprising the steps of:
i) determining a first weight ratio of the second polymer component (B) to the first polymer component (A) in the second polymerisation step, and
ii) increasing the concentration of the induced swelling agent in the second polymerisation step if the determined first weight ratio is less than the predetermined target weight ratio, or
iii) decreasing the concentration of the induced swelling agent in the second polymerisation step if the determined first weight ratio is greater than the predetermined target weight ratio, or
iv) maintaining the concentration of the induced swelling agent in the second polymerisation step if the determined first weight ratio equals the predetermined target weight ratio.

The disclosure further relates to use of an induced swelling agent in a gas phase polymerisation step for improving gas phase production split in a multi-stage olefin polymerisation process. According to an embodiment of the disclosure the induced swelling agent is inert C4-10-alkane and/or C5-10-comonomer, preferably selected from a group consisting of butane, pentane, heptane, 1-pentene, 1-hexene and mixtures thereof, in particular n-butane, n-pentane, n-heptane, 1-pentene, 1-hexene and mixtures thereof. Preferably the induced swelling agent is inert C4-10-alkane, more preferably selected from a group consisting of butane, pentane, heptane and mixtures thereof.

Adjustment of the concentration of the induced swelling agent in the second polymerisation reactor to a desirable level increases the catalyst productivity and further improves the GPR production split and broadens the product window of a multi-stage polymerisation processes that operate for long overall residence time.

### Process

The present disclosure relates to a multistage polymerisation process using a polymerisation catalyst, said process comprising an optional but preferred prepolymerisation step, followed by a first and a second polymerisation step.

Preferably, the same catalyst is used in each step and ideally, it is transferred from prepolymerisation to subsequent polymerisation steps in sequence in a well-known manner.

Accordingly, the present process for polymerising olefins in multi stage polymerisation process configuration, comprises
a) polymerising in a first polymerisation step first olefin monomer, optionally in the presence of at least one other alpha olefin monomer, in the presence of a polymerisation catalyst so as to form a first polymer component (A) and
b) polymerising in a second polymerisation step in gas phase second olefin monomer, optionally in the presence of at least one other alpha olefin comonomer, in the presence of the first polymer component (A) of step a) and an induced swelling agent, so as to for a second polymer component (B).

### Prepolymerisation Step

Polymerisation steps may be preceded by a prepolymerisation step. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is preferably conducted in slurry and the amount of polymer produced in an optional prepolymerisation step is counted to the amount (wt %) of ethylene polymer component (A).

The catalyst components are preferably all introduced to the prepolymerisation step when a prepolymerisation step is present. Preferably the reaction product of the prepolymerisation step is then introduced to the first polymerisation step.

However, where the solid catalyst component and the cocatalyst can be fed separately it is possible that only a part of the cocatalyst is introduced into the prepolymerisation stage and the remaining part into subsequent polymerisation stages. Also in such cases it is necessary to introduce so much cocatalyst into the prepolymerisation stage that a sufficient polymerisation reaction is obtained therein.

It is understood within the scope of the invention, that the amount or polymer produced in the prepolymerisation lies within 1 to 7 wt % in respect to the final multimodal (co)polymer. This can be counted as part of the first ethylene polymer component (A) produced in the first polymerisation step a).

### First Polymerisation Step a)

In the present process the first polymerisation step a) involves polymerising olefin monomer and optionally at least one olefin comonomer.

In one embodiment the first polymerisation step involves polymerising ethylene to produce ethylene homopolymer.

In another embodiment the first polymerisation step involves polymerising ethylene and at least one olefin comonomer to produce ethylene copolymer.

The first polymerisation step may take place in any suitable reactor or series of reactors. The first polymerisation step may take place in one or more slurry polymerisation reactor(s) or in a gas phase polymerisation reactor, or a combination thereof. Preferably the first polymerisation step takes place in one or more slurry polymerisation reactor(s), more preferably in at least three (e.g. exactly three) slurry phase reactors including a slurry-phase reactor for carrying out pre-polymerisation.

The polymerisation in the first polymerisation zone is preferably conducted in slurry. Then the polymer particles formed in the polymerisation, together with the catalyst fragmented and dispersed within the particles, are suspended in the fluid hydrocarbon. The slurry is agitated to enable the transfer of reactants from the fluid into the particles.

The slurry polymerisation usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons. An especially preferred diluent is propane, possibly containing minor amount of methane, ethane and/or butane.

The ethylene content in the fluid phase of the slurry may be from 2 to about 50% by mole, preferably from about 3 to about 20% by mole and in particular from about 5 to about 15% by mole. The benefit of having a high ethylene concentration is that the productivity of the catalyst is increased but the drawback is that more ethylene then needs to be recycled than if the concentration was lower.

The temperature in the slurry polymerisation is typically from 50 to 115° C., preferably from 60 to 110° C. and in particular from 70 to 100° C. The pressure is from 1 to 150 bar, preferably from 10 to 100 bar.

The pressure in the first polymerisation step is typically from 35 to 80 bar, preferably from 40 to 75 bar and in particular from 45 to 70 bar.

The residence time in the first polymerisation step is typically from 0.15 h to 3.0 h, preferably from 0.20 h to 2.0 h and in particular from 0.30 to 1.5 h.

It is sometimes advantageous to conduct the slurry polymerisation above the critical temperature and pressure of the fluid mixture. Such operation is described in U.S. Pat. No. 5,391,654. In such operation, the temperature is typically from 85 to 110° C., preferably from 90 to 105° C. and the pressure is from 40 to 150 bar, preferably from 50 to 100 bar.

The slurry polymerisation may be conducted in any known reactor used for slurry polymerisation. Such reactors include a continuous stirred tank reactor and a loop reactor. It is especially preferred to conduct the polymerisation in loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186, and U.S. Pat. No. 5,391,654.

The slurry may be withdrawn from the reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295, EP-A-1591460, and EP3178853B1.

Hydrogen may be fed into the reactor to control the molecular weight of the polymer as known in the art. Furthermore, one or more alpha-olefin comonomers may be added into the reactor to control the density of the polymer product. The actual amount of such hydrogen and comonomer feeds depends on the catalyst that is used and the desired melt index (or molecular weight) and density (or comonomer content) of the resulting polymer.

### Second Polymerisation Step b)

From the first polymerisation step the first polymer component is transferred to the second polymerisation step.

In the present process the second polymerisation step b) involves polymerising olefin monomer and optionally at least one olefin comonomer.

In one embodiment the second polymerisation step involves polymerising ethylene and optionally at least one olefin comonomer to produce ethylene homopolymer or ethylene copolymer, respectively.

The second polymerisation step takes place in one or more gas phase polymerisation reactor(s).

The gas phase polymerisation may be conducted in any known reactor used for gas phase polymerisation. Such reactors include a fluidized bed reactor, a fast fluidized bed reactor or a settled bed reactor or in any combination of these. When a combination of reactors is used then the polymer is transferred from one polymerisation reactor to another. Furthermore, a part or whole of the polymer from a polymerisation stage may be returned into a prior polymerisation stage.

The gas phase polymerisation is conducted in gas-solids fluidized beds, also known as gas phase reactors (GPR). Gas solids olefin polymerisation reactors are commonly used for the polymerisation of alpha-olefins such as ethylene and propylene as they allow relative high flexibility in polymer design and the use of various catalyst systems. A common gas solids olefin polymerisation reactor variant is the fluidized bed reactor.

A gas solids olefin polymerisation reactor is a polymerisation reactor for heterophasic polymerisation of gaseous olefin monomer(s) into polyolefin powder particles, which comprises three zones: in the bottom zone the fluidization gas is introduced into the reactor; in the middle zone, which usually has a generally cylindrical shape, the olefin monomer(s) present in the fluidization gas are polymerised to form the polymer particles; in the top zone the fluidization gas is withdrawn from the reactor. In certain types of gas solids olefin polymerisation reactors a fluidization grid (also named distribution plate) separates the bottom zone from the middle zone. In certain types of gas solids olefin polymerisation reactors the top zone forms a disengaging or entrainment zone in which due to its expanding diameter compared to the middle zone the fluidization gas expands and the gas disengages from the polyolefin powder.

The dense phase denotes the area within the middle zone of the gas solids olefin polymerisation reactor with an increased bulk density due to the formation of the polymer particles. In certain types of gas solids olefin polymerisation reactors, namely fluidized bed reactors, the dense phase is formed by the fluidized bed.

The temperature in the gas phase polymerisation is typically from 50 to 100° C., preferably from 65 to 90° C.

The pressure in the gas phase polymerisation is typically from 5 to 40 bar, preferably from 10 to 35 bar, preferably from 15 to 30 bar.

The residence time in the gas phase polymerisation is from 1.0 h to 4.5 h, preferably from 1.5 h to 4.0 h and in particular from 2.0 to 3.5 h.

The molar ratios of the reactants are adjusted as follows: C6/C2 ratio of 0.0001-0.1 mol/mol, H2/C2 ratio of 0-0.1 mol/mol.

The polymer production rate in the gas phase reactor may be from 10 tn/h to 65 tn/h, preferably from 12 tn/h to 58 tn/h and in particular from 13 tn/h to 52.0 tn/h, and thus the total polymer withdrawal rate from the gas phase reactor may be from 15 tn/h to 100 tn/h, preferably from 18 tn/h to 90 tn/h and in particular from 20 tn/h to 80.0 tn/h.

The production split (A/B) may be from 30% to 60% first polymer component and from 70% to 40% second polymer component, preferably from 35% to 55% first polymer component and from 65% to 45% second polymer component and in particular from 38% to 50% first polymer component and from 62% to 50% second polymer component.

The gas phase polymerisation may be conducted in any known reactor used for gas phase polymerisation. Such reactors include a fluidized bed reactor, a fast fluidized bed reactor or a settled bed reactor or in any combination of these. When a combination of reactors is used then the polymer is transferred from one polymerisation reactor to another. Furthermore, a part or whole of the polymer from a polymerisation stage may be returned into a prior polymerisation stage.

### Controlling the Predetermined Target Weight Ratio

In the present process, the predetermined target weight ratio is controlled by adjusting the amount of an induced swelling agent in the second polymerisation step.

The term “predetermined target weight ratio” refers to the ratio of the second polymer component (B), produced in the second polymerisation step, to the first polymer component (A), produced in the first polymerisation step.

The predetermined target weight ratio (B)/(A) is typically from 0.65 to 2.5, preferably from 0.8 to 2.3, more preferably from 0.92 to 1.9 and most preferably from 1.0 to 1.65.

The predetermined weight ratio is controlled by
(i) determining the weight ratio of the second polymer component (B) to the first polymer component (A) in the second polymerisation reactor;
(ii) increasing the concentration of an induced swelling agent in the second polymerisation reactor if the determined weight ratio of the second polymer to the first polymer in the second polymerisation reactor is less than the target weight ratio; or
(iii) decreasing the concentration of an induced swelling agent in the second polymerisation reactor if the determined weight ratio of the second polymer to the first polymer in the second polymerisation reactor is greater than the target weight ratio; or
(iv) maintaining an essentially concentration of an induced swelling agent in the second polymerisation reactor if the determined weight ratio of the second polymer to the first polymer in the second polymerisation reactor equals the target weight ratio.

### Induced Swelling Agent

The term “induced swelling agent” used herein refers to a compound capable of permeating the shell and swelling the core of a polymer particle, in particular due to mass uptake. Thus, the induced swelling agent is capable of sorbing into the polymer particles produced in the polymerisation process in the presence of the said polymer particles and monomers, in particular under the conditions of the specific process for which the swelling agent is used. The term “induced” as used herein in particular refers to intentional aim to create a swelling effect and that the swelling effect is not merely caused because of a circumstantial presence of a component which is anyhow required for the process. Preferably, the induced swelling agent is used to create as high as possible degree of swelling.

The induced swelling agent may be the same comonomer used in the second polymerisation step and/or an inert chemical compound that is part of the reaction medium. The induced swelling agent is a high molecular weight hydrocarbon, preferably selected from C4-10-alkanes (such as n-heptane, n-butane, n-pentane and any isomers thereof) and C5-10-comonomer (such as 1-hexene). Preferably, the induced swelling agent is butane, pentane, heptane, 1-pentene or 1-hexene or a mixture thereof, more preferably n-butane, n-pentane, n-heptane, 1-pentene or 1-hexene or a mixture thereof.

The concentration of the induced swelling agent in the second polymerisation step b) is controlled by the total concentration of oligomers (i.e., expressed as C6-C14 components) in the gas phase reactor, measured by on-line gas chromatographer.

The total concentration of oligomers, i.e. C6-14 components, in the second polymerisation step is typically in the range 50 to 1200 ppm, preferably lower than 600 ppm, more preferably lower than 500 ppm, most preferably lower than 400 ppm of the total amount of the reaction mixture.

The induced swelling agent may be introduced to the reactor via an injection line that is placed at the bottom of the gas phase reactor and it is mixed with the recirculation gas stream that in turn is introduced into the gas phase reactor.

The presence of induced swelling agents, e.g. high molecular weight hydrocarbons, in the gas phase polymerisation step surprisingly is a key factor in increasing the catalyst productivity in the gas phase polymerisation when single-site catalysts are involved, in particular without necessity to operate the reactor under condensed mode. The sorption of heavy alkanes or alkenes in the polymer particles largely affects the concentration of the reactants and the chain transfer agents (e.g., ethylene, hydrogen, higher alpha olefins, etc.) during PE gas phase polymerisation, thus playing a critical role in enhancing the catalyst productivity in the gas phase reactor in a multi-stage, multi-phase PE polymerisation process.

### Polymerisation Catalyst

The polymerisation catalyst utilized in the present process is a metallocene catalyst. The polymerisation catalyst typically comprises (i) a transition metal complex, (ii) a cocatalyst, and optionally (iii) a support.

Preferably the first and the second polymerisation step are performed using, i.e. in the presence of, the same metallocene catalyst.

The present process preferably utilizes single-site catalysis. Polyethylene copolymers made using single-site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

### Transition Metal Complex (i)

The transition metal complex comprises a transition metal (M) of Group 3 to 10 of the Periodic Table (IUPAC 2007) or of an actinide or lanthanide.

The term “transition metal complex” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the transition metal complex (i) has the following formula (i-I):

(L)ₘRₙMX_{q} (i-I)

wherein
“M” is a transition metal (M) of Group 3 to 10 of the Periodic Table (IUPAC 2007),
each “X” is independently a monoanionic ligand, such as a σ-ligand,
each “L” is independently an organic ligand which coordinates to the transition metal “M”,
“R” is a bridging group linking said organic ligands (L),
“m” is 1, 2 or 3, preferably 2
“n” is 0, 1 or 2, preferably 0 or 1,
“q” is 1, 2 or 3, preferably 2 and
m+q is equal to the valence of the transition metal (M).
“M” is preferably selected from the group consisting of zirconium (Zr), hafnium (Hf), or titanium (Ti), more preferably selected from the group consisting of zirconium (Zr) and hafnium (Hf).
“X” is preferably a halogen, most preferably Cl.

Most preferably, the transition metal complex (i) is a metallocene complex, which comprises a transition metal compound, as defined above, which contains a cyclopentadienyl, indenyl or fluorenyl ligand as the substituent “L”. Further, the ligands “L” may have one or more substituents, such as alkyl groups, aryl groups, arylalkyl groups, alkylaryl groups, silyl groups, siloxy groups, alkoxy groups or other heteroatom groups or the like. Suitable metallocene catalysts are known in the art and are disclosed, among others, in WO-A-95/12622, WO-A-96/32423, WO-A-97/28170, WO-A-98/32776, WO-A-99/61489, WO-A-03/010208, WO-A-03/051934, WO-A-03/051514, WO-A-2004/085499, EP-A-1752462 and EP-A-1739103.

In an embodiment of the invention the metallocene complex is bis(1-methyl-3-n-butylcyclopentadienyl) zirconium (IV) chloride.

In another embodiment, the transition metal complex (i) has the following formula (i-II):

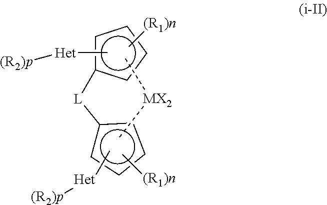

wherein each X is independently a halogen atom, a C1-6-alkyl, C1-6-alkoxy group, phenyl or benzyl group;
each Het is independently a monocyclic heteroaromatic containing at least one heteroatom selected from O or S;
L is -R′2Si—, wherein each R′ is independently C1-20 hydrocarbyl or C1-10 alkyl substituted with alkoxy having 1 to 10 carbon atoms;
M is Ti, Zr or Hf;
each R₁ is the same or different and is a C1-6 alkyl group or C1-6 alkoxy group;
each n is 1 to 2;
each R₂ is the same or different and is a C1-6 alkyl group, C1-6 alkoxy group or —Si(R)3 group;
each R is C1-10 alkyl or phenyl group optionally substituted by 1 to 3 C1-6 alkyl groups; and
each p is 0 to 1.

Preferably, the compound of formula (i-II) has the structure (i-III)

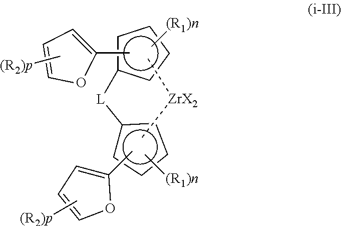

wherein each X is independently a halogen atom, a C1-6-alkyl, C1-6-alkoxy group, phenyl or benzyl group;
L is a Me2Si—;
each R₁ is the same or different and is a C1-6 alkyl group, e.g. methyl or t-Bu; each n is 1 to 2;
R₂ is a —Si(R)3 alkyl group; each p is 1;
each R is C1-6 alkyl or phenyl group.

Highly preferred transition metal complexes of formula (i-II) are

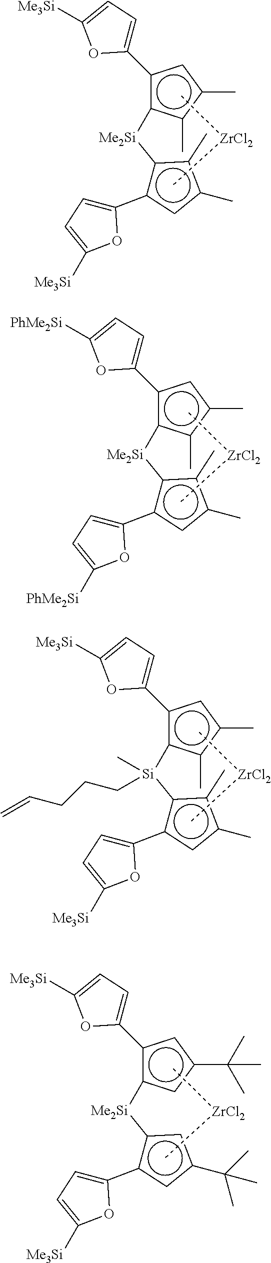

### Cocatalyst (ii)

To form a polymerisation catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Suitable cocatalysts are metal alkyl compounds and especially aluminium alkyl compounds known in the art. Especially suitable activators used with metallocene catalysts are alkylaluminium oxy-compounds, such as methylalumoxane (MAO), tetraisobutylalumoxane (TIBAO) or hexaisobutylalumoxane (HIBAO).

Preferably the cocatalyst is methylalumoxane (MAO).

Support (iii)

It is possible to use the present polymerisation catalyst in solid but unsupported form following the protocols in WO03/051934. The present polymerisation catalyst is preferably used in solid supported form. The particulate support material used may be an inorganic porous support such as a silica, alumina or a mixed oxide such as silica-alumina, in particular silica.

The use of a silica support is preferred.

Especially preferably, the support is a porous material so that the complex may be loaded into the pores of the particulate support, e.g. using a process analogous to those described in WO94/14856, WO95/12622, WO2006/097497 and EP1828266.

The average particle size of the support such as silica support can be typically from 10 to 100 μm. The average particle size (i.e. median particle size, D₅₀) may be determined using the laser diffraction particle size analyser Malvern Mastersizer 3000, sample dispersion: dry powder.

The average pore size of the support such as silica support can be in the range 10 to 100 nm and the pore volume from 1 to 3 mL/g.

Examples of suitable support materials are, for instance, ES757 produced and marketed by PQ Corporation, Sylopol 948 produced and marketed by Grace or SUNSPERA DM-L-303 silica produced by AGC Si-Tech Co. Supports can be optionally calcined prior to the use in catalyst preparation in order to reach optimal silanol group content.

The catalyst can contain from 5 to 500 μmol, such as 10 to 100 μmol of transition metal per gram of support such as silica, and 3 to 15 mmol of Al per gram of support such as silica.

### Multimodal Polyethylene Polymer

The present invention concerns the preparation of a multimodal polyethylene homopolymer or copolymer. The density of the multimodal ethylene homopolymer or copolymer may be between 900 and 980 kg/m³, preferably 905 to 940 kg/m³, especially 910 to 935 kg/m³.

It is preferred if the multimodal polyethylene polymer is a copolymer. More preferably, the multimodal polyethylene copolymer is an LLDPE. It may have a density of 905 to 940 kg/m³, preferably 910 to 935 kg/m³, more preferably 915 to 930 kg/m³, especially of 916 to 928 kg/m³. In one embodiment a range of 910 to 928 kg/m³ is preferred. The term LLDPE used herein refers to linear low density polyethylene. The LLDPE is preferably multimodal.

The term “multimodal” includes polymers that are multimodal with respect to MFR and includes also therefore bimodal polymers. The term “multimodal” may also mean multimodality with respect to the “comonomer distribution”.

Usually, a polymer comprising at least two polyethylene fractions, which have been produced under different polymerisation conditions resulting in different (weight average) molecular weights and molecular weight distributions for the fractions, is referred to as “multimodal”. The prefix “multi” relates to the number of different polymer fractions present in the polymer. Thus, for example, the term multimodal polymer includes so called “bimodal” polymers consisting of two fractions. The form of the molecular weight distribution curve, i.e. the appearance of the graph of the polymer weight fraction as a function of its molecular weight, of a multimodal polymer, e.g. LLDPE, may show two or more maxima or at least be distinctly broadened in comparison with the curves for the individual fractions. Often the final MWD curve will be broad, skewered or displaying a shoulder.

Ideally, the molecular weight distribution curve for multimodal polymers of the invention will show two distinct maxima. Alternatively, the polymer fractions have similar MFR and are bimodal in the comonomer content. A polymer comprising at least two polyethylene fractions, which have been produced under different polymerisation conditions resulting in different comonomer content for the fractions, is also referred to as “multimodal”.

For example, if a polymer is produced in a sequential multi-stage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In any multimodal polymer, there may be a lower molecular weight component (LMW) and a higher molecular weight component (HMW). The LMW component has a lower molecular weight than the higher molecular weight component. This difference is preferably at least 5000 g/mol.

The multimodal polyethylene polymer produced by the present process preferably comprises at least one C4-10-comonomer. Comonomers may be present in the HMW component (or second component (B), produced in the second polymerisation step) or the LMW component (or first component (A), produced in the first polymerisation step) or both.

From hereon, the term LMW/HMW component will be used but the described embodiments apply to the first and second components respectively.

It is preferred if the HMW component comprises at least one C4-10-comonomer. The LMW component may then be an ethylene homopolymer or may also comprise at least one C4-10-comonomer. In one embodiment, the multimodal polyethylene polymer contains a single comonomer. In a preferred embodiment, the multimodal polyethylene polymer comprises at least two, e.g. exactly two, C4-10 comonomers.

The overall comonomer content in the multimodal polyethylene polymer may be for example 0.2 to 14.0% by mol, preferably 0.3 to 12% by mol, more preferably 0.5 to 10.0% by mol and most preferably 0.6 to 8.5% by mol. 1-Butene may be present in an amount of 0.05 to 6.0% by mol, such as 0.1 to 5% by mol, more preferably 0.15 to 4.5% by mol and most preferably 0.2 to 4% by mol.

The C6 to C10 alpha olefin may be present in an amount of 0.2 to 6% by mol, preferably 0.3 to 5.5% by mol, more preferably 0.4 to 4.5% by mol.

Preferably, the LMW component has lower amount (mol %) of comonomer than the HMW component, e.g. the amount of comonomer, preferably of 1-butene in the LMW component is from 0.05 to 0.9 mol %, more preferably from 0.1 to 0.8 mol %, whereas the amount of comonomer, preferably of 1-hexene in the HMW component (B) is from 1.0 to 8.0 mol %, more preferably from 1.2 to 7.5 mol %.

The LMW component of the multimodal polyethylene polymer may have a MFR2 of 0.5 to 3000 g/10 min, more preferably 1.0 to 1000 g/10 min. In some embodiments, the MFR2 of the LMW component may be 50 to 3000 g/10 min, more preferably 100 to 1000 g/10 min, e.g. where the target is a cast film.

The molecular weight (Mw) of the LMW component should preferably range from 20,000 to 180,000, e.g. 40,000 to 160,000. It may have a density of at least 925 kg/m³, e.g. at least 940 kg/m³. A density in the range of 930 to 950 kg/m³, preferably of 935 to 945 kg/m³ is possible.

The HMW component of the multimodal polyethylene polymer may, for example, have an MFR2 of less than 1 g/10 min, such as 0.2 to 0.9 g/10 min, preferably of 0.3 to 0.8 and more preferably of 0.4 to 0.7 g/10 min. It may have a density of less than 915 kg/m³, e.g. less than 910 kg/m³, preferably less than 905 kg/m³. The Mw of the higher molecular weight component may range from 70,000 to 1,000,000, preferably 100,000 to 500,000.

The LMW component may form 30 to 70 wt % of the multimodal polyethylene polymer such as 35 to 65 wt %, especially 38 to 62 wt %.

The HMW component may form 30 to 70 wt % of the multimodal polyethylene polymer such as 35 to 65 wt %, especially 38 to 62 wt %.

In one embodiment, there is 40 to 45 wt % of the LMW component and 60 to 55 wt % of the HMW component.

In one embodiment, the polyethylene polymer consists of the HMW and LMW components as the sole polymer components.

The multimodal polyethylene polymer of the invention may have a MFR2 of 0.01 to 50 g/10 min, preferably 0.05 to 25 g/10 min, especially 0.1 to 10 g/10 min.

### EXAMPLES

### Catalyst

### Loading of SiO₂:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Example 1 (Comparative)

A single-site catalyst, having an initial size of 25 microns, span (i.e., (d90-d10)/d50) of 1.6 was used to produce LLDPE film. The catalyst was first prepolymerised in a prepolymerisation reactor at T=50° C. and P=65 barg. More specifically, 900 kg/h of ethylene, 95 kg of 1-butene per tn ethylene, 0.27 Kg hydrogen per tn of propane and 6.50 tn propane/h (diluent) were fed to prepoly reactor and the mean residence time was 30 mins. The product was transferred to a split loop reactor having volume equal to 80 m³. Ethylene (C2), propane (diluent), 1-butene (C4) and hydrogen (H2) were fed to the reactors and the polymerisation conditions were T=85° C., P=64 barg and the mean residence time was equal to 1.0 h. The molar ratio of H2/C2 and C4/C2 were 2 mol/kmol and 100 mol/kmol, respectively, and the overall production rate in the loop reactor was 25 tn/h (the overall productivity was 2.5 kg/gcat). Then, the material flushed out in a high pressure separator and during the transition from the slurry to gas-phase process, n-heptane at different concentrations has been added (Examples 2-3). In all cases, the polymerisation process in the gas-phase reactor continues for residence time equals to 2.5 hours (in all examples), overall pressure of 20 barg, temperature of 75° C. and gas phase composition of 52.5% mol propane, 10% mol nitrogen, 32.5% mol ethylene, 5% mol C6 and H2/C2=0.5 mol/kmol. The size of the gas phase reactor has been 3.5 m diameter, the fluidized bed height has been 17 m and the superficial gas velocity (SGV) was equal to 0.5 m/s. The overall mass flow rate of the recirculation gas was 520 tn/h, the final material properties have been density equal to 914 kg/m³ and MFI equal to 1.2.

In this example, no amount of n-heptane (i.e., induced swelling agent-ISA) was added to the gas phase reaction. The overall catalyst productivity in GPR was 3.5 kg/gcat. The production split value was equal to 55% that corresponds to 30.6 tn/h production in GPR and 55.6 tn/h overall throughput.

### Example 2 (Inventive-IE1)

The procedure of Example 1 was repeated with the exception that n-heptane was added in the GPR, so that the concentration of the heptane in the gas phase was 0.5% mol (nitrogen concentration in gas phase was 9.5% mol). The catalyst productivity in GPR was 4.0 kg/gcat. The production split value was equal to 58% that corresponds to 34.5 tn/h production in GPR and 59.5 tn/h overall throughput.

### Example 3 (Inventive-IE2)

The procedure of Example 1 was repeated with the exception that n-heptane was added in the GPR, so that the concentration of the heptane in the gas phase was 1.0% mol (nitrogen concentration in gas phase was 9.0% mol). The catalyst productivity in GPR was 4.3 kg/gcat. The production split value was equal to 60% that corresponds to 37.5 tn/h production in GPR and 62.5 tn/h overall throughput.

Table 1 summarizes the examples outcome.

TABLE 1
Summary of the results.

| | | ISA (n-C7, | Throughput | GPR |
|---|---|---|---|---|
| Example | SGV (m/s) | % mol) | (tn/h) | Split (%) |
| CE1 | 0.5 | 0.0 | 55.6 | 55 |
| IE1 | 0.5 | 0.5 | 59.5 | 58 |
| IE2 | 0.5 | 1.0 | 62.5 | 60 |

The presence of an induced swelling agent in the gas phase reactor resulted in significant increase of the catalyst productivity that in turn led to the production rate in the gas phase reactor and to the overall throughput without affecting the final product properties and the reactor operability.

1. A process for polymerising olefins in multi stage polymerisation process configuration, the process comprising:
a) polymerising in a first polymerisation step a first olefin monomer, optionally in the presence of at least one other alpha olefin monomer, in the presence of a polymerisation catalyst so as to form a first polymer component (A), and
b) polymerising in a second polymerisation step in gas phase a second olefin monomer, optionally in the presence of at least one other alpha olefin comonomer, in the presence of the first polymer component (A) of step a) and an induced swelling agent, so as to form a second polymer component (B),
wherein the first polymer component (A) and the second polymer component (B) are produced at production rates meeting a predetermined target weight ratio of the second polymer component (B) to the first polymer component (A), the process comprising the steps of:
i) determining a first weight ratio of the second polymer component (B) to the first polymer component (A) in the second polymerisation step, and
ii) increasing the concentration of the induced swelling agent in the second polymerisation step when the determined first weight ratio is less than the predetermined target weight ratio, or
iii) decreasing the concentration of the induced swelling agent in the second polymerisation step when the determined first weight ratio is greater than the predetermined target weight ratio, or
iv) maintaining the concentration of the induced swelling agent in the second polymerisation step when the determined first weight ratio equals the predetermined target weight ratio.

2. The process according to claim 1, wherein the induced swelling agent is an inert C4-10-alkane and/or C5-10-comonomer.

3. The process according to claim 1, wherein in the second polymerisation step the pressure is from 3 to 30 bar and the residence time is at least 1.5 hours.

4. The process as claimed in claim 1, wherein the polymerisation catalyst is a single-site catalyst.

5. The process according to claim 1, wherein the polymerisation catalyst comprises (i) a transition metal complex, (ii) a cocatalyst, and optionally (iii) a support.

6. The process according to claim 1, wherein the second polymerisation step has a total amount of a reaction mixture, and the second polymerisation step has a total concentration of oligomers in the range 50 to 1200 ppm of the total amount of the reaction mixture.

7. The process according to claim 1, wherein the predetermined target weight ratio (B)/(A) is between 0.65 to 2.5.

8. A method of use of an induced swelling agent in a gas phase polymerisation step for improving gas phase production split in a multi-stage olefin polymerisation process.

9. The method of use as claimed in claim 8, wherein the induced swelling agent is an inert C4-10-alkane.

10. The method of use as claimed in claim 8, wherein the gas phase polymerisation step has a total amount of a reaction mixture, and wherein the gas phase polymerisation step has a total concentration of oligomers in the range 50 to 1200 ppm of the total amount of the reaction mixture.

11. The process of claim 1, wherein the induced swelling agent is selected from the group consisting of butane, pentane, heptane, 1-pentene, 1-hexene, and mixtures thereof.

12. The process of claim 1, wherein the polymerisation catalyst is a metallocene catalyst.

13. The process of claim 6, wherein the total concentration of oligomers is the total concentration of C6-14 components.

14. The process of claim 6, wherein the total concentration of oligomers is in the range of 50 to 600 ppm of the total amount of the reaction mixture.

15. The process according to claim 1, wherein the predetermined target weight ratio (B)/(A) is from 0.8 to 2.3.

16. The process according to claim 1, wherein the predetermined target weight ratio (B)/(A) is between 0.92 to 1.9.

17. The process according to claim 1, wherein the predetermined target weight ratio (B)/(A) is between 1.0 to 1.65.

18. The method of use of claim 8, wherein the induced swelling agent is selected from the group consisting of butane, pentane, heptane, and mixtures thereof.

19. The method of use of claim 10, wherein the total concentration of oligomers is the total concentration of C6-14 components.

20. The method of use of claim 10, wherein the total concentration of oligomers is in the range of 50 to 600 ppm of the total amount of the reaction mixture.
